(19) United States
(12) Patent Application Publication
(10) Pub. No.: US 2025/0206891 A1
(43) Pub. Date: Jun. 26, 2025

(54) METHYLATION OF KRAFT LIGNIN

(71) Applicant: FPINNOVATIONS, Pointe-Claire (CA)

(72) Inventors: Daniel BEAUDOIN, Pointe-Claire (CA); Ernest PALUS, Pointe-Claire (CA)

(21) Appl. No.: 18/844,597

(22) PCT Filed: Mar. 16, 2023
(86) PCT No.: PCT/CA2023/050334

§ 371 Date: Sep. 6, 2024

Related U.S. Application Data
(60) Provisional application No. 63/320,427, filed on Mar. 16, 2022.

(51) Int. Cl. C08H 7/00

(52) U.S. Cl. CPC C08H 6/00

(57) ABSTRACT

There is provided a process of methylating lignin. The process includes providing an alkaline aqueous phase, which includes lignin, in a reactor chamber. The reactor chamber is pressurized with a gas phase including methyl chloride gas. The reactor chamber is heated to methylate the lignin and obtain methylated lignin.

### CROSS-REFERENCE TO RELATED APPLICATIONS

This application claims priority to U.S. Provisional Patent Application No. 63/320,427 filed Mar. 16, 2022, the contents of which is incorporated herein by reference in its entirety.

### TECHNICAL FIELD

This disclosure relates to the field of methylated kraft lignin and a process of obtaining same.

### BACKGROUND OF THE ART

The methylation of lignin has been performed with a variety of methods with methyl precursors such as diazomethane, dimethyl sulfate, iodomethane, and dimethyl carbonate and trimethyl phosphate. However, the methods involving these precursors generally involve toxic reactants to be able to methylate the lignin. For example, diazomethane is toxic and is explosive rendering diazomethane an undesirable methane source for methylation reactions. Moreover, these methylation methods are limited to the methylation of OH groups from phenol functionalities only and/or generate by-products that are difficult to separate from unreacted methylating agents. Accordingly, improvements in the methylation of lignin is desired, for example to reduce or eliminate toxic reactants and problematic by-products.

### SUMMARY

In one aspect, there is provided a process of methylating lignin, the process comprising: providing an alkaline aqueous phase comprising lignin in a reactor chamber; pressurizing the reactor chamber with a gas phase comprising methyl chloride gas; and heating the reactor chamber to methylate the lignin and obtain methylated lignin.

In one embodiment, the process further comprises precipitating the methylated lignin.

In one embodiment, the step of precipitating the methylated lignin comprises acidifying the alkaline aqueous phase to obtain an acidified aqueous phase.

In one embodiment, the acidified aqueous phase has a pH of less than 4.

In one embodiment, the process further comprises, after the step of precipitating, separating the methylated lignin.

In one embodiment, the separating is a filtration or a centrifugation step.

In one embodiment, the alkaline aqueous phase has a pH of 8 or more.

In one embodiment, pressurizing the reactor chamber comprises pressurizing to obtain a methyl chloride pressure of from 1 to 1000 psi.

In one embodiment, the process further comprises repressurizing the reactor chamber when the methyl chloride pressure falls below 25 psi.

In one embodiment, the process further comprises continuously maintaining the methyl chloride pressure at or above 25 psi.

In one embodiment, the step of pressurizing the reactor chamber is performed at room temperature.

In one embodiment, the step of heating comprises heating to a temperature of at least 80° C.

In one embodiment, the temperature is from 25 to 250° C.

In one embodiment, the process further comprises repressurizing the reactor chamber at pre-determined time intervals.

In one embodiment, the alkaline aqueous phase is a sodium hydroxide solution.

In one embodiment, the alkaline aqueous phase has a pH ranging from 8-14.

In one embodiment, at least 10% of hydroxyl and carboxyl groups of the lignin are methylated to obtain the methylated lignin as measured by 31P nuclear magnetic resonance (NMR).

In one embodiment, the methylated lignin has a molecular weight that is less than 50% larger than that of the lignin.

In one embodiment, the lignin is methylated by a methylation reaction which is stopped before a pH of the aqueous phase becomes less than 7.

In one embodiment, the process further comprises washing the methylated lignin.

Many further features and combinations thereof concerning the present improvements will appear to those skilled in the art following a reading of the instant disclosure.

### DESCRIPTION OF THE DRAWINGS

FIG. 1 is a graph showing the linear relationship between the mass average molar mass of methylated lignins as determined by multi-angle light scattering and the severity factor of the methylation process.

FIG. 2 is a quantitative 31P NMR spectrum of unmodified softwood kraft lignin.

FIG. 3 is a quantitative 31P NMR spectrum of softwood kraft lignin methylated with methyl chloride.

FIG. 4 is a quantitative 31P NMR spectrum of unmodified hardwood kraft lignin.

FIG. 5 is a quantitative 31P NMR spectrum of hardwood kraft lignin methylated with methyl chloride.

FIG. 6 is a chart showing DSC curves for unmodified softwood kraft lignin (-) and softwood kraft lignin methylated with methyl chloride (- - -).

FIG. 7 is a chart showing DSC curves for unmodified hardwood kraft lignin (-) and hardwood kraft lignin methylated with methyl chloride (- - -).

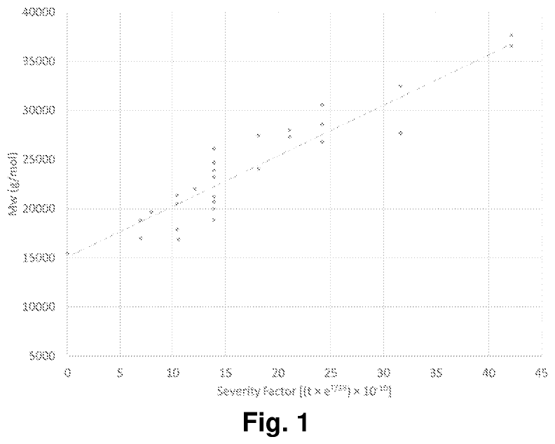

### DETAILED DESCRIPTION

As encompassed herein, it is disclosed methylated lignin and a process of obtaining same.

It is provided a process of methylating lignin, the process comprising providing an alkaline aqueous phase comprising lignin in a reactor chamber; pressurizing the reactor chamber with a gas phase comprising methyl chloride gas; and heating the reactor chamber to methylate the lignin and obtain methylated lignin.

Lignin is a non-linear polymer characterized by a relatively high molar mass (MW) and a compact structure as a result of significant intramolecular and intermolecular hydrogen bonding and pi-pi interactions. Kraft lignin can be obtained from an alkaline degradation of wood and kraft pulping. However, the source of lignins contemplated in the present disclosure can vary. In some embodiments discussed, kraft lignins from softwoods and hardwoods can be used, but the disclosure is not limited to only such sources. Rather, the present disclosure encompasses the use of a large variety of lignin sources, including those from annual plants. The present disclosure allows the use of lignin that significantly exceed the traditional sources of the pulp and paper industry. These can include organosolv lignins, milled wood lignins, steam explosion lignins, acid hydrolysis lignins, enzymatic hydrolysis lignins and lignins from other pulping processes, from wood or agricultural crops.

Lignins are rich in phenolic, aliphatic, and carboxylic hydroxyl groups. The present disclosure describes a process that can methylate all types of hydroxyl functional groups present in lignins. Furthermore, it describes procedures that allow not only the methylation process to occur but also identifies and solves complications related to the degradation of lignins during the methylation process. Moreover, the present disclosure can solve issues related to the isolation of the methylated lignin products produced in aqueous media.

For certain industrial applications it is desirable to methylate lignin to improve its physico-chemical properties for the specific industrial application. Methylation of lignin is a method used to impart hydrophobicity or to increase the hydrophobicity of lignin. In addition, methylation increases the thermal stability of lignins thus facilitating their thermomechanical processing. With increased or imparted hydrophobicity the lignin can become compatible with other hydrophobic polymers. For example, methylated lignin can form miscible blends with polypropylene, polyesters (e.g. aliphatic polyesters), natural rubbers or polyethers leading to improved mechanical properties.

The present disclosure provides a process for methylating lignin. The methylation is performed in an alkaline aqueous phase with methyl chloride gas. When lignin becomes methylated it precipitates out of the alkaline aqueous phase and can be recovered by filtration for example. As the degree of methylation increases the precipitation increases. Methylated lignin can be filtered out and washed to obtain a washed methylated lignin for industrial applications.

The methylation of lignin generally refers to the methylation of hydroxyl groups (generally phenolic groups) and carboxyl groups (generally carboxyl as a substituent of an aromatic ring such as benzene). In some cases, the methylation performed in the present disclosure may achieve near-complete methylation of phenolic and carboxylic groups of lignin. In some embodiments, the methylation also includes the methylation of at least a portion of the aliphatic alcohol groups in lignin. In further embodiments, the present process leads to the concomitant methylation of phenols, aliphatic alcohols, and carboxylic acids. Accordingly, in some embodiments, the methylation reaction of the present process is defined as a reaction that replaces the hydrogen of an —OH group with a methyl group to yield a methoxy-OCH₃ group. This methylation reaction therefore increases the hydrophobicity of the molecule. The methylation of lignin can also increase the thermal stability limiting condensation crosslinking reactions, thus facilitating the thermomechanical processing for incorporation into polymer materials.

The lignin can in some embodiments be dissolved in the alkaline aqueous phase thereby making an alkaline aqueous solution. In one example, the alkaline aqueous phase is a sodium hydroxide solution. Alternatively, other alkaline solutions comprising lithium hydroxide, potassium hydroxide, sodium carbonate, potassium carbonate and others can be used. The sodium hydroxide can be present in the solution in a concentration ranging from 0.001 to 20 mmol/mL. In some embodiments, the NaOH is present in a concentration of from 0.005 to 0.5 g/mL. In some embodiments, the pH of the alkaline aqueous phase is 9 or more, 10 or more, 11 or more, or 12 or more.

The alkaline aqueous phase is provided in a reactor chamber that can be pressurized with a gas phase. More specifically, the reactor chamber is pressured with a gas phase comprising methyl chloride gas. In some embodiments, the gas phase is methyl chloride gas. The present process can maintain two separate phases during the methylation reaction, the alkaline aqueous phase being liquid and a gas phase comprising methyl chloride. Methyl chloride can be present in the alkaline aqueous phase as it is partially soluble in water. The reactor chamber is pressurized to obtain a methyl chloride pressure of from 1 to 2000 psi, from 1 to 500 psi, from 1 to 300 psi, from 5 to 200 psi, from 10 to 100 psi, from 30 to 50 psi, from 31 to 49 psi, from 32 to 48 psi, from 33 to 47 psi, from 34 to 46 psi, from 35 to 45 psi, from 36 to 44 psi, from 37 to 43 psi or about 40 psi (i.e. 40±5% psi). To maintain the methyl chloride pressure the reactor chamber can be reversibly hermetically sealed. In some embodiments, the reactor chamber comprises the gas phase above the alkaline aqueous phase (i.e. the liquid phase). The pressurizing of the reactor chamber can be performed at room temperature, for example between 18 and 30° C. or at 22-25° C.

To accelerate the methylation reaction of lignin, the reactor chamber is heated. In some embodiments, the reactor chamber is heated to a temperature of at least 80° C., at least 85° C., or at least 90° C. It is preferred to have a temperature of at least 80° C. for the reaction to operate within a reasonable industrial timeframe. However, the process can be performed at lower temperatures. In some embodiments, the reactor chamber is heated to a temperature of from 25 to 250° C., from 80 to 225° C., from 80 to 200° C., from 80 to 170° C., from 80 to 150° C., from 80 to 120° C., from 85 to 115° C. or from 90 to 110° C.

During the methylation reaction, the reactor chamber can optionally be repressurized. The reactor chamber may be repressurized if the methyl chloride pressure drops below a certain threshold and/or can be repressurized at pre-determined time intervals (e.g. every 30 mins, every 1 h, etc.). In one example, the reactor chamber is repressurized if the methyl chloride pressure drops below 35 psi, below 33 psi, below 30 psi, below 28 psi, below 25 psi, below 20 psi or below 18 psi. The repressurization brings back the methyl chloride pressure to what it was initially at the beginning of the reaction i.e. the pressure at which the reactor chamber was pressurized. The temperature applied will affect the pressure and consequently the repressurization, particularly the vapor pressure of water will increase with increasing temperatures. In some embodiments, the reactor chamber pressure can be continuously controlled to be above 25 psi, above 30 psi, or above 35 psi. In one example, the reactor chamber can be continuously controlled to be within ±10% or ±5% of what the initial pressure is.

The temperature and time of the methylation are factors that can be controlled to avoid the degradation of the lignins. For example, the mass average molar mass of softwood kraft lignin increases when high temperatures and/or long methylation times are applied during the methylation process. This can be advantageous if an increase in molar mass is desired, but otherwise can also be prevented by selecting the methylation conditions.

When the lignin becomes methylated (i.e. methylated lignin) it precipitates from the alkaline aqueous phase. In some embodiments, to promote and facilitate the precipitation, an acid is added to the alkaline aqueous phase to acidify the alkaline aqueous phase and obtain an acidified aqueous phase. In some embodiments, the acidified aqueous phase has a pH of less than 4, less than 3.5, less than 3 or equal or less than 2.5. After the precipitation the methylated lignin can be separated, for example by filtration and then washed. The waste materials produced by the present process can comprise or consist of sodium chloride, which is ubiquitous in nature and can be disposed of with relative ease and low environmental impact.

The traditional methylation of lignin in an organic solvent usually begins and ends with homogenous solutions. However, when methylation is done in aqueous phase as described herein, the reaction begins with a homogenous solution but ends with a suspension. In the present case, the suspensions comprises large, agglomerated masses which may complicate the isolation of the methylated lignins. By controlling the pH of the methylation, it is possible to stop the reaction at a point where the agglomerated masses can be broken down with hot water. For example, the pH of the initial lignin solution can be 12-13 and is gradually lowered as the methylation reactions takes place. If the methylation reactions are allowed to proceed for extended periods of time, the pH of the final mixture may be as low as 1-2. When the reaction is stopped at pH >7, it is easier to break down the agglomerated product by stirring them in water, preferably at temperatures of 90-95° C. When the reaction is stopped at pH <7, the agglomerated product can be difficult to break down by stirring them in water. However, and hot pressurized water at temperatures of 120-150° C. can nevertheless be used to break down the aggregates.

In some embodiments, the obtained methylated lignin has a molecular weight that is less than 50% larger, less than 45% larger, or less than 40% larger that of the lignin. In some embodiments, at least 10%, at least 30%, at least 60%, at least 80% or at least 90% of hydroxyl and carboxyl groups of the lignin are methylated to obtain the methylated lignin as measured by 31P nuclear magnetic resonance (NMR). In some cases, the methylation reaction can last until at least 10%, at least 30%, at least 60%, at least 80% or at least 90% of hydroxyl and carboxyl groups of the lignin are methylated.

The present process can be operated in a continuous fashion. In a non-limitative example, a heated static mixer can receive the alkaline aqueous phase containing lignin (and methyl chloride liquefied in some cases) and the gaseous phase containing methyl chloride. The methylated lignin can be recovered at the end of the mixer and the process therefore run continuously. In such embodiments, as described above, the pressure can be continuously controlled to be above 25 psi, above 30 psi, or above 35 psi.

The process of the present disclosure therefore provides an improved methylation of lignin that avoids toxic by-products and reactants. The process described herein is economical as well as environmentally friendly when compared to prior art lignin methylations. The process generates a small volume/quantity of waste (e.g. sodium chloride) when compared to the prior art lignin methylations. Advantages of the process according to the present disclosure include but are not limited to (i) the use of an aqueous phase as the reaction media which is low cost, available and advantageous to operate, (ii) the use of a low-cost, low toxicity methylation agent, namely the gaseous phase comprising methyl chloride (iii) a reduction in the overall cost of the methylation by avoiding the use of organic solvents (iv) the waste chemical produced is sodium chloride which can be efficiently disposed of in a lignin plant (v) the process can effectively and concomitantly methylate phenolic and aliphatic alcohols as well as carboxylic acids in a single reaction step, and (iv) the separation of the methylated lignin from excess methylating agent is efficient and easy since methyl chloride is in a gaseous form.

### Example: Methylation of Kraft Lignin

Softwood kraft lignin (80 g) was dissolved in a solution of sodium hydroxide (22.4 g) in water (700 mL). The resulting mixture was charged in a 1.8-L stainless steel reactor and stirred mechanically. The vessel was closed, and the atmosphere within the vessel was replaced with methyl chloride (40 psi). The vessel was heated to 90° C. for 4 h. The pressure of methyl chloride was maintained at 40 psi throughout the whole reaction by means of a check valve. The vessel was then cooled to room temperature, vented, and opened. The liquid portion was decanted and set aside, then water (800 mL) was added to the reactor. The vessel was closed and was heated to 95° C. for 1 h. The vessel was then cooled to room temperature and opened. The liquid portion previously set aside was poured into the reactor, the pH of the mixture was adjusted to 2-3 with diluted sulfuric acid. The resulting suspension was filtered, the collected solids were washed with water and air-dried to afford methylated softwood kraft lignin (80 g).

Hardwood kraft lignin (80 g) was dissolved in a solution of sodium hydroxide (22.4 g) in water (700 mL). The resulting mixture was charged in a 1.8-L stainless steel reactor and stirred mechanically. The vessel was closed, and the atmosphere within the vessel was replaced with methyl chloride (40 psi). The vessel was heated to 90° C. for 4 h. The pressure of methyl chloride was maintained at 40 psi throughout the whole reaction by means of a check valve. The vessel was then cooled to room temperature, vented, and opened. The liquid portion was decanted and set aside, then water (800 mL) was added to the reactor. The vessel was closed and was heated to 95° C. for 1 h. The vessel was then cooled to room temperature and opened. The liquid portion previously set aside was poured into the reactor, the pH of the mixture was adjusted to 2-3 with diluted sulfuric acid. The resulting suspension was filtered, the collected solids were washed with water and air-dried to afford methylated hardwood kraft lignin (77 g).

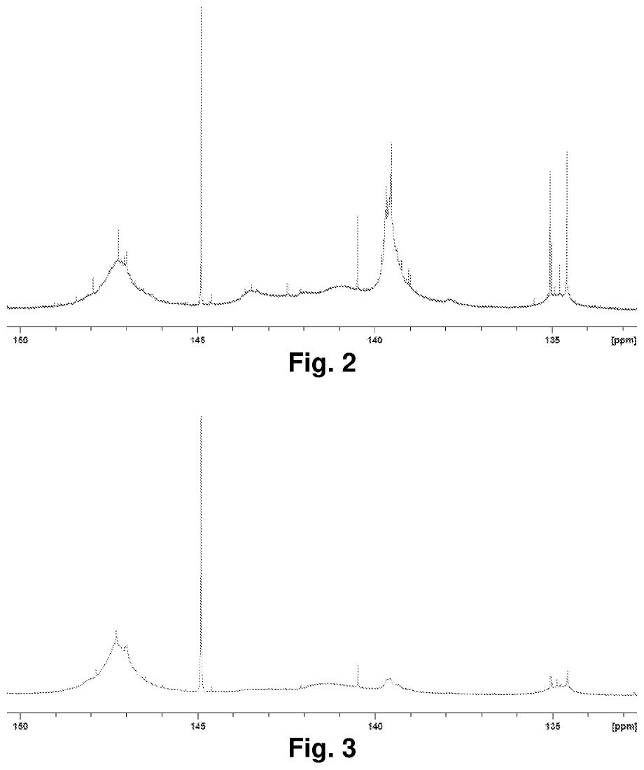

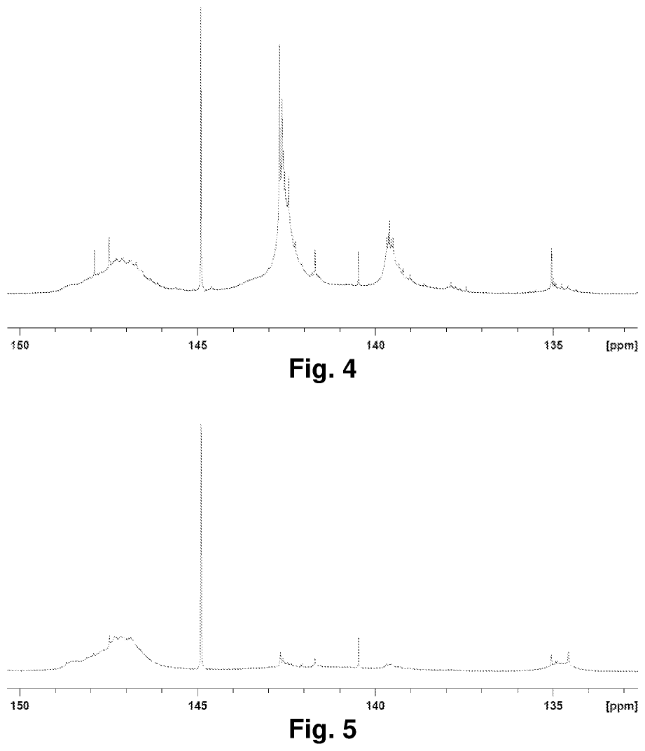

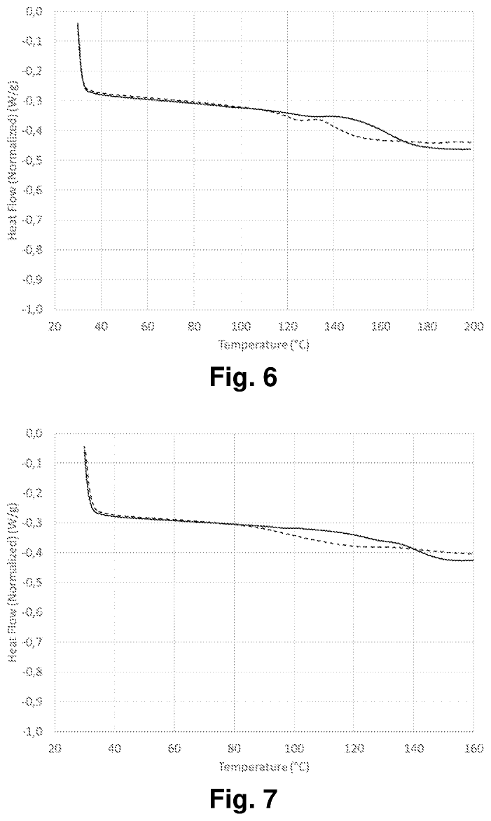

The concentrations of hydroxyl groups in the kraft lignin used and in the methylated lignin produced as described above were determined by ³¹P NMR (FIG. 2, FIG. 3, FIG. 4 and FIG. 5) and are listed in Table 1. The glass transition temperatures were determined by DSC (FIG. 6 and FIG. 7) and are also listed in Table 1.

TABLE 1
Glass transition temperatures (DSC) and concentrations of hydroxyl
groups in lignins and methylated lignins (³¹P NMR).

| | | Aliphatic | Phenolic | Carboxylic |
|---|---|---|---|---|
| | Tg | OH | OH | OH |
| Lignin | (° C.) | (mmol/g) | (mmol/g) | (mmol/g) |
| Softwood kraft | 161.7 | 1.92 | 4.03 | 0.54 |
| lignin | | | | |
| Methylated | 142.5 | 1.48 | 0.97 | 0.22 |
| softwood kraft | | | | |
| lignin | | | | |
| Hardwood Kraft | 142.1 | 1.82 | 4.28 | 0.27 |
| lignin | | | | |
| Methylated | 100.9 | 1.63 | 0.72 | 0.24 |
| hardwood kraft | | | | |
| lignin | | | | |

While the present disclosure has been described in connection with specific embodiments thereof, it will be understood that it is capable of further modifications and this application is intended to cover any variations, uses, or adaptations including such departures from the present disclosure as come within known or customary practice within the art and as may be applied to the essential features hereinbefore set forth, and as follows in the scope of the appended claims.

1: A process of methylating lignin, the process comprising:
providing an alkaline aqueous phase comprising the lignin in a reactor chamber;
pressurizing the reactor chamber with a gas phase comprising methyl chloride gas; and
heating the reactor chamber to methylate the lignin and obtain methylated lignin.

2: The process of claim 1, further comprising precipitating the methylated lignin.

3: The process of claim 2, wherein the step of precipitating the methylated lignin comprises acidifying the alkaline aqueous phase to obtain an acidified aqueous phase.

4: The process of claim 3, wherein the acidified aqueous phase has a pH of less than 4.

5: The process of claim 1, further comprising, after the step of precipitating, separating the methylated lignin.

6: The process of claim 5, wherein the separating is a filtration or a centrifugation step.

7: The process of claim 1, wherein the alkaline aqueous phase has a pH of 8 or more.

8: The process of claim 1, wherein the pressurizing of the reactor chamber comprises pressurizing said reactor chamber to obtain a methyl chloride pressure of from 1 to 2000 psi.

9: The process of claim 1, further comprising repressurizing the reactor chamber when the methyl chloride pressure falls below 25 psi.

10: The process of claim 1, further comprising continuously maintaining the methyl chloride pressure at or above 25 psi.

11: The process of claim 1, wherein the step of pressurizing the reactor chamber is performed at room temperature.

12: The process of claim 1, wherein the step of heating comprises heating to a temperature of at least 25° C.

13: The process of claim 12, wherein the temperature is from 25 to 250° C.

14: The process of claim 1, further comprising the repressurizing of the reactor chamber at pre-determined time intervals.

15: The process of claim 1, wherein the alkaline aqueous phase is a sodium hydroxide solution.

16: The process of claim 15, wherein the alkaline aqueous phase has a pH ranging from 8-14.

17: The process of claim 1, wherein at least 10% of hydroxyl and carboxyl groups of the lignin are methylated to obtain the methylated lignin as measured by 31P nuclear magnetic resonance (NMR).

18: The process of claim 1, wherein the methylated lignin has a molecular weight that is less than 50% larger than that of the lignin.

19: The process of claim 1, wherein the lignin is methylated by a methylation reaction which is stopped before a pH of the aqueous phase becomes less than 7.

20: The process of claim 1, further comprising washing the methylated lignin.
